(19) United States
(12) Patent Application Publication
(10) Pub. No.: US 2001/0035436 A1
(43) Pub. Date: Nov. 1, 2001

(54) Double opening container

(76) Inventors: Patrick L. Foley, Zionsville, IN (US); Patrick L. Foley, Zionsville, IN (US)

Correspondence Address: Patrick L. Foley, 7259 Hunt Club Lane, Zionsville, IN, 46077, US

(21) Appl. No.: 09/780,542

(22) Filed: Jun. 6, 2001

Related U.S. Application Data
(60) Provisional application No. 60/182,140, filed on Feb. 12, 2000.

(51) Int. Cl. B67D 5/40; A47G 19/24; B67D 3/00; B67D 5/06

(52) U.S. Cl. 222/482; 222/383.1; 222/565; 222/524; 222/525; 222/534; 222/536

(57) ABSTRACT

A double opening container of various sizes and shapes having different size openings at either end. The larger opening serves as the base with a wide enough diameter relative to the size of the container to allow the container to stand securely on this end. The screw on caps provide for ease of dispensing, refilling and washing the container from the larger opening. The smaller opening serves as the dispensing end with interchangable caps depending on the application for use. Both ends and their caps have adaptable threads and screw on caps to provide tight enough application to prevent leakage. The container and caps are composed of a durable material such as plastic to allow for repeated washing, drying and reuse.

### BACKGROUND

1. Field of Invention

This invention relates to reuseable containers, specifically those used to store and dispense their contents.

2. Description of Prior Art

Grocery stores and other vendors provide for sale various sizes of containers/bottles for storing a variety of substances both edible and inedible.

These containers/bottles come in different sizes and shapes with regard to length, diameter, and contents capacity. They have a single opening at the top of the container for dispensing its contents.

Consumers objected because of the singular use of the container. After it was empty, it was difficult to clean, refill, and reuse the container because of the singular opening. It thereby required disposal and repurchase of another container.

Lack of reuse creates increased waste and cost. Allowing easy access to the inside of the container for washing, drying, and refilling from a larger bulk container or water faucet/water source provides for better ecological and economical use.

Inventors have created double opening containers. U.S. Pat. No. 5,829,607 to Ibrahim, Moheb M. (Nov. 3, 1998) “double ended bottle” shows a bottle with double openings. The bottle, however, does not vary the size of the openings. Although it can dispense from both ends, the equal size small openings make it difficult to wash, dry, and refill for reuse.

U.S. Pat. No. 5,803,268 to Levy, Brad, Levy, Judy, and DuGrenier, Robert (Sep. 8, 1998) “double ended perfume bottle” shows a bottle with double opening. The bottle, however, does not vary the size of the openings. Although it can dispense from both ends, the equal size spray openings make it impossible to wash, dry, and refill for reuse. The bottle also separates the internal contents by means of a septum/divider making the bottle even more difficult to wash, dry, refill and reuse.

U.S. Pat. No. 4,618,076 to Silvenus, Scott A. (Oct. 21, 1986) “dual dispensing bottle” shows a spray bottle with double openings on one end for dispensing its contents. The single vessel container has a small opening making it difficult to wash, dry, refill, and reuse. The bottle does vary the size of the two openings on the one end of the bottle. Although it can dispense from both openings, the small size spray openings make it difficult to wash, dry, refill, and reuse.

U.S. Pat. No. 4,078,686 to Karesh, Myrna M. (March 1978) “two way jar” shows a double opening jar with same size openings on either end and removable internal containers with a divider between the upper and lower parts of the jar. Although the container can be opened at either end and easily washed, dried, and reused the same size large openings do not accomodate ease of controlled dispensing from one end or the other. The divider also inhibits the full use of the container as a single entity and decreases the full amount of its contents.

U.S. Pat. No. D363,858 to Sweeney, Bruce (Nov. 7, 1995) “double beverage container” shows a double opening container with attached handle. The container has the same size openings on either end with a removable screw on cap covering the plugged openings. The caps have a diameter on either end sufficient enough to allow the container to stand on either end. Both openings are however of the same size making it difficult to wash, rinse, and dry the container. The equal size small openings make the container suitable for holding only liquid contents or substances of a non viscous and non solid nature.

U.S. Pat. No. 5,158,191 to Douglas, Jerry and Schmidt, Godfried (Oct. 27, 1992) “dual bottle container” shows two containers with an interlocking connection. This allows the containers to be placed together and used as a single container with two separate openings. The bottles both have a single opening of equal size on one end of the container. This makes it difficult to clean, dry, and refill the containers. The dual interlocking bottles separate the contents of both and decrease the available volume held in either bottle. The small dual openings make the container suitable for only liquid contents or substances of a non solid nature.

### OBJECTS AND ADVANTAGES

Accordingly, besides the objects and advantages of the double opening container in my above patent, several objects and advantages of the present invention are:

(a) to provide a container which can be produced in various sizes with a scaled up or down mold.

(b) to provide a container made of non-breakable and reuseable material (ie: plastic) that allows for ease of frequent washing and drying within a range of temperature variations.

(c) to provide a container with an opening at either end, of different sizes, to allow the container to be refilled with ease from the larger opening and its contents dispensed with ease and control of flow from the smaller opening.

(d) to provide a container whose opening at the smaller end can accept a variety of reuseable caps including but not limited to: closed caps, spray caps, pull open caps, flip-up spout caps, and perforated caps.

(e) to provide a container whose double opening at either end is of a threaded type to accomodate various aforementioned caps all of which have are screw on type of appropriate size to accomodate the threaded opening of the various bottle size openings.

(f) to provide a container with an opening at either end, one opening of which is always wide enough in diameter relative to the container size to allow the container to stand securely on this end as its base.

(g) to provide a container made of a clear nonbreakable and reuseable plastic to allow ease of viewing and identifying its contents and level of fill.

(h) to provide a container whose double threaded ends and screw on caps are leakage proof when securely tightened and are easily unscrewed for opening of either or both ends.

### DRAWING FIGURES AND PHOTOS

In the drawings, closely related figures have the same number but different alphabetic suffixes.

FIGS. 1A to 1D shows various views of the container.

FIGS. 2A to 2C shows various views of the screw on caps.

FIGS. 3A to 3E shows optional caps which are interchangable.

Reference Numerals to Drawings

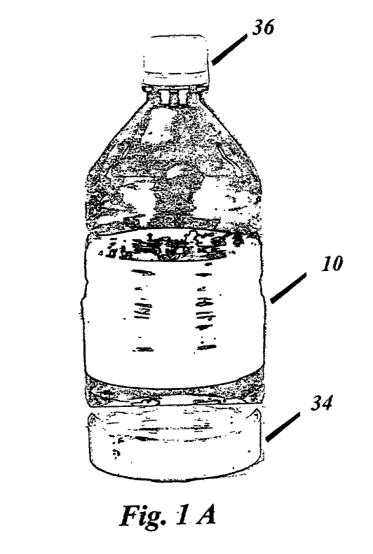

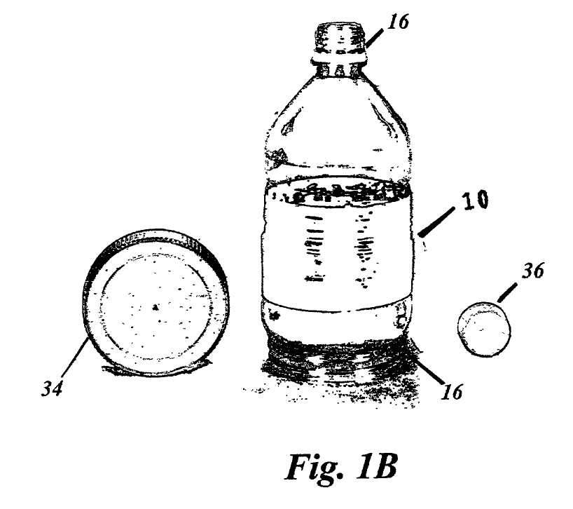

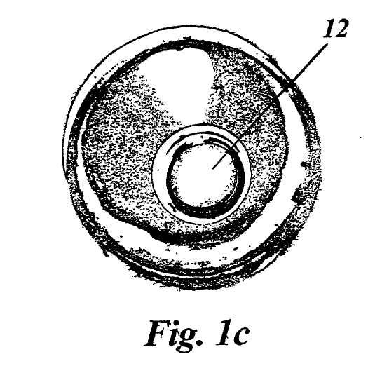

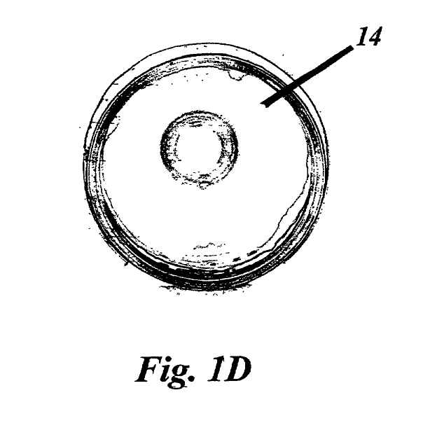

10 container with caps on (FIG. 1A) and caps removed (FIG. 1B).

12 smaller upper opening top view (FIG. 1C)

14 larger lower opening bottom view (FIG. 1D)

16 threaded ends of container (FIG. 1B)

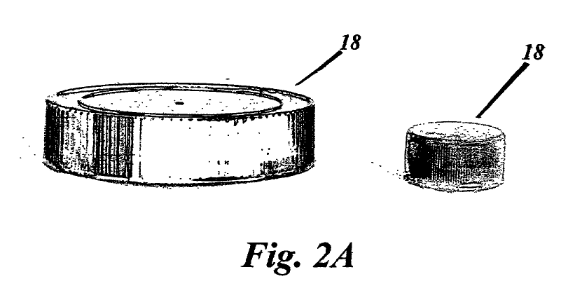

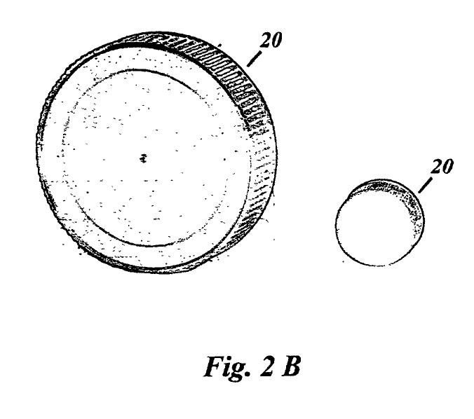

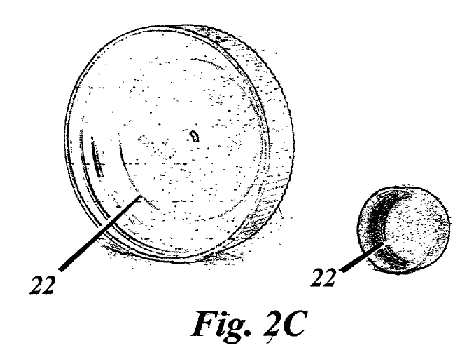

18 caps side view (FIG. 2A)—closed cap variety, top and bottom

20 caps top view (FIG. 2B)—closed cap variety, top and bottom.

22 cap inside view (FIG. 2C)-closed cap variety, top and bottom.

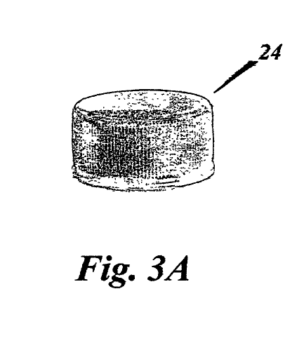

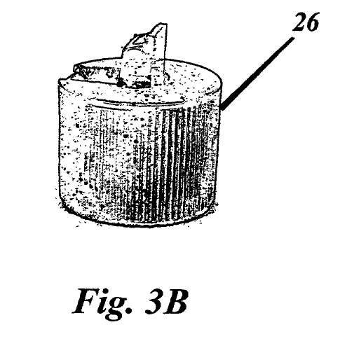

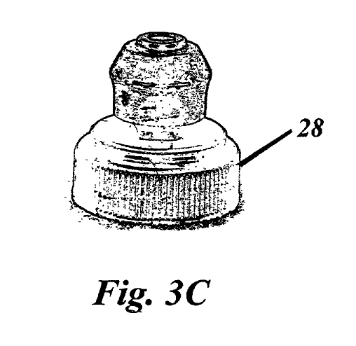

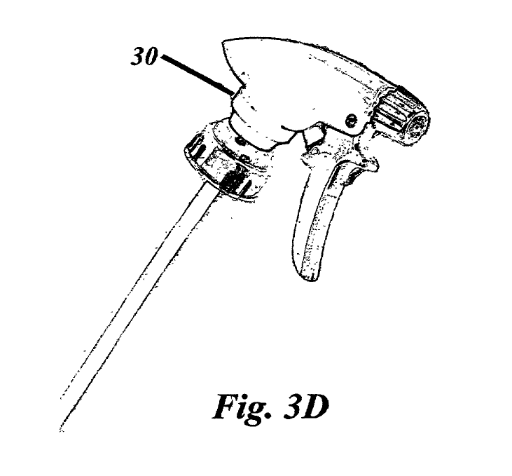

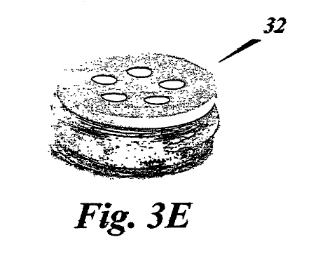

24 optional screw on closed cap side view (FIG. 3A)

26 optional screw on flip-up spout cap side view (FIG. 3B)

28 optional screw on pull-up spout cap side view (FIG. 3C)

30 optional screw on spray cap side view (FIG. 3D)

32 optional screw on perforated cap side view (FIG. 3D)

34 larger base cap-closed end (FIG. 1A)

36 smaller dispensing cap-optional varieties above (FIG. 1A)

### SUMMARY

In accordance with the present invention, a reuseable container, bottle shaped, having two openings one at either end. Each opening of different size. One opening of which is wide enough in diameter relative to the size of the container to allow the container to stand securely on this end. Both openings allowing for repeated opening and closing, the larger opening for ease of refill, washing, and drying and the smaller opening for ease of dispensing its contents.

### DESCRIPTION

A typical embodiment of the container is illustrated in FIG. 1A and FIG. 1B (side view). The container is bottle shaped with an open top and bottom of various sizes (FIGS. 1B, 1C 12, 1D 14). The container consists of reuseable molded plastic able to withstand repeated washing and drying and temperature fluctuations.

At one end of the container is a larger diameter opening of sufficient size to allow the container to stand securely on this end as its base. (FIGS. 1A 34 1B 16, 34) At the other end of the container is a smaller opening sufficient to allow dispensing its contents in a controlled manner. (FIGS. 1A 36 1B 16,36) Both open ends of the container allow for dispensing its contents. The larger diameter opening is included to allow for ease of washing and drying and refilling the container. (FIGS. 1A 34 1B 16,34 1D 14) The open ends of the container are each threaded (FIG. 1B 16) to accomodate appropriate sized caps of optional variety including but not limited to closed cap (FIG. 3A 24), flip up spout cap (FIG. 3B 26), pullup cap (FIG. 3C 28), spray cap (FIG. 3D 30), and perforated cap (FIG. 3E 32). The caps are all screw on variety (FIG. 2C 22) of appropriate size to accomodate the small and large threaded openings of the container respectively (FIG. 1B 16). The larger opening of the container will accomodate a flat threaded closed cap of sufficient size to serve as the base on which to stand the container (FIGS. 1A 34 1B 16,34 2C 22). The smaller opening of the container will accomodate the optional threaded caps of smaller diameter to serve as the dispensing unit of the container (FIGS. 1A 36 1B 16,36 3A-3E 24-32). Both threaded ends (FIG. 1B 16) of the container and threaded screw on caps (FIG. 2C 22) are of sufficient security and tightness to prevent leakage from either end when closed. The plastic container is clear to allow for ease of viewing its contents for both level of fill and

Operation

The manner of using the double opening container is identical to containers in present use. Namely, one opens the screw on cap of the container to dispense its contents in desired amounts and then closes the container with the same screw on cap to retain its contents without leakage.

The screw on caps at either end of the double opening container can be removed individually for dispensing and/or refilling and can both be removed together for flushing, cleaning, and drying the container.

FIG. 1B (side view) shows the container (10) with the caps on either end removed from the container. (34, 36)

FIG. 2A (side view) shows the closed type (18) screw on caps for the top and the bottom of the container.

Conclusions, Ramifications, and Scope

Accordingly, the reader will see that the double opening container can be used to store dispense, and refill a substance easily and conviently.

In addition, it allows ease of labeling to identify the contents of the clear plastic container by means of removable adherent stickers.

It permits easy washing, drying, and reusing of the same container either by hand or machine wash method.

In addition, it provides a wide bottom base/opening on which to stand the container securely.

I claim:

1. A container and dispenser kit assembly (1A), said kit assembly comprising the following elements,
an elongated body portion (1A, 10) having an upper tapered area (1A, 10),
said elongated body (1A, 10) having external threads (1B, 16) formed at upper and lower portions thereof respectively,
said kit further comprising an upper covering cap (1A, 36, 1B, 36) having threads (1B, 16) for attachment to an upper end (1B, 16) of said elongated body portion,
said kit further including a lower support cap (1A, 34, 1B, 34) for attachment to a lower end (1B, 16) of said elongated body portion,
wherein the upper cap (1A, 36, 1B, 36) is substantially smaller than the lower support cap so that the kit components, when disassembled, may be easily cleaned for reuse,
said kit further including at least one secondary upper cap (3A, 24, 3B, 26, 3C, 28, 3D, 30, 3E, 32) and dispenser.

2. The container and dispenser kit assembly of claim 1 wherein said kit further includes:
a threaded flip-up spout cap (3B, 26),
a threaded spray cap (3D, 30),
a threaded perforated cap (3E, 32),
and a threaded pull-up cap (3C, 28),
means to use differing upper caps (3A, 24, 3B, 26, 3C, 28, 3D, 30, 3E, 32) depending on the material used within the container body (1A, 10, 1B, 10).

3. A method of cleaning a plastic container for reuse, said plastic container having a smaller upper dispensing end and a smaller cap (1B, 16, 36) mounted thereon, said plastic container further having a larger lower support cap (1B, 16, 34) mounted thereon, the method steps comprising,
a) removing said upper and lower caps (1A, 36, 34, 1B, 36, 34),
b) cleaning said plastic container,
c) replacing said lower support cap (1A, 34, 1B, 34),
d) providing an upper covering (3A, 24, 3B, 26, 3C, 28, 3D, 30, 3E, 32) for the liquid or solid used in the container.

4. A plastic bottle structure having a smaller threaded opening (1B, 16) and a larger threaded lower opening (1B, 16),
a smaller cap (1A, 36, 1B, 36) mounted on said upper opening,
a larger support cap (1A 34, 1B, 34) mounted on said lower opening,
means for removing said upper and lower caps so the plastic bottle structure may be easily cleaned and flushed,
means for replacing said lower cap (1A, 34, 1B, 34) and means for replacing said upper cap by utilizing the original cap or a selected cap (3A, 24, 3B, 26, 3C, 28, 3D, 30, 3E, 32) depending on the substance to be place in the plastic bottle.
